(19) United States
(12) Patent Application Publication
(10) Pub. No.: US 2010/0154533 A1
(43) Pub. Date: Jun. 24, 2010

(54) ARRANGEMENT WITH AT LEAST ONE FLOW-THROUGH MEASURING DEVICE FOR FLUIDS

(75) Inventors: Zubeyde Al Sukhi, Nussbaumen (CH); Martin Naier, Lustenau (AT); Christoph Schneider, Lindau (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: KRAL AG, Lustenau (AT)

(21) Appl. No.: 12/644,437

(22) Filed: Dec. 22, 2009

(30) Foreign Application Priority Data
Dec. 22, 2008 (AT) A2001/2008

(51) Int. Cl. G01F 3/08

(52) U.S. Cl. 73/254

(57) ABSTRACT

An arrangement having at least one flow meter (1) for fluids, particularly liquids, and with at least one bypass line (2), via which fluids can be guided past the flow meter (1), with the flow meter (1) including at least one rotationally supported measuring spindle (3). The arrangement includes a housing block (4) with at least one inlet opening (5) and at least one outlet opening (6), and the flow meter (1) and the bypass line (2) are arranged inside the housing block (4), with the inlet opening (5) being connected to the outlet opening (6) in a first operating state via the flow meter (1) and in at least a second operating state via the bypass line (2.)

### CROSS-REFERENCE TO RELATED APPLICATIONS

This application claims the benefit of Austrian Patent Application Number A 2001/2008, filed Dec. 22, 2008, which is incorporated herein by reference as if fully set forth.

### BACKGROUND

The present invention relates to an arrangement having at least one flow meter for fluids, particularly liquids, and having at least one bypass line via which the fluids can be guided past the flow meter, with the flow meter at least comprising one rotationally supported measuring spindle.

In generic devices, two or more measuring spindles are used as the measuring organs in flow meters and/or volume meters. Such flow meters are very precise and operate according to a transparent and comprehensive measuring principle, in which the flow rate is calculated from the number of rotations of the measuring spindle(s). Another advantage of this type of flow meters is the sleek design and the development of only a small loss in pressure. However, it is problematic in such flow meters that contaminants or the like can relatively quickly result in a blockage of the measuring spindle. Therefore, generic arrangements always require a bypass line, via which the fluids and/or liquids can be guided past the then blocked flow meter. However, the necessity of the provision of such bypass lines then compromises the sleek design of the flow meters of prior art, particularly when considering that additional valves must be provided for switching bypass lines and flow meters of prior art.

### SUMMARY

The object of the invention is to provide a solution for generic arrangements, allowing a small and/or sleek design of the arrangement in spite of the necessity of a bypass line.

This is achieved by placing the arrangement in a housing block having at least one inlet opening and at least one outlet opening, the flow meter and the bypass line being arranged inside the housing block, and in a first operating state the inlet opening being connected to the outlet opening via the flow meter and in at least one second operating state via the bypass line.

The fundamental idea of the invention is therefore to provide a housing block, in which both the bypass line and the flow meter are integrated. Bypass lines and flow meters are therefore arranged jointly inside the housing block. This allows the desired compact design. In a first operating state, the arrangement according to the invention allows connection of the inlet opening to the outlet opening of the housing block via the flow meter. In a second operating state, when the flow meter is not operational or is to be circumvented for any other reason, the inlet opening of the housing block can be directly connected to the outlet opening via the bypass line.

As known per se from prior art, the flow meter comprises not only one but at least two, perhaps even three or more rotationally supported measuring spindles as the measuring organ that engage each other. The housing block is preferably embodied in one piece, particularly preferred as a one-piece molded part. The pipeline system provided in the housing block between the inlet opening and the outlet opening is beneficially embodied as a fluidic-connected sequence of hollow spaces and/or bores in the otherwise, at least essentially, massive housing block. In order to allow switching between the first and the second operating state advantageous at least one switching organ is arranged inside the housing block, operated manually and/or motor-driven, with in the first operating state the switching organ connecting the inlet opening to the outlet opening via the flow meter and in the second operating state via the bypass line. In the sense of a compact and easily operated arrangement, particular beneficial embodiments of the invention provide that precisely one switching organ is arranged inside the housing block.

Using said switching organ, at times freely selected and/or desired by the operating personnel or by an automated supervisory device it can be switched between the first operating state and the second operating state.

In case that an unpredicted blockage or clogging of the flow meter occurs a preferred embodiment of the invention provides that an additional bypass line is arranged within the housing block via which fluids can be guided past the flow meter. Seen in the direction of flow of the fluids, this additional bypass line preferably forks off a line section between the inlet opening and the flow meter, leading to the flow meter and to an outlet opening. Beneficially, a pressure relief valve is arranged in the additional bypass line, which is opened by the fluid flowing through the arrangement and/or the housing block when a preferably adjustable pressure limit is exceeded.

For reasons of completeness it shall be pointed out that of course such a pressure relief valve is not necessarily arranged in an additional bypass line but may also be located directly in the primary bypass line. In such embodiments, for example when it is not necessary, the switching organ to be operated manually and/or motor-driven can be omitted.

A particularly preferred embodiment of the invention provides that a pipeline system is provided within the housing block, connecting the inlet opening to the outlet opening, in at least two levels, preferably arranged over top of each other. Here, it is preferably provided that the inlet opening and the outlet opening are arranged together in one level. It is also beneficial for the bypass line and the switching organ to be arranged jointly in one level, with particularly preferred embodiments providing that the inlet opening and the outlet opening and the bypass line and the switching organ are jointly arranged in one level. Then, beneficially the flow meter is arranged in another level, preferably together with a pressure relief valve arranged in the additional bypass line. By the tiered design a particularly compact arrangement results.

### BRIEF DESCRIPTION OF THE DRAWINGS

Additional features and details of preferred embodiments of the present invention are discernible from the following description of the figures.

Shown are:

FIG. 1 is a schematic view of an arrangement according to prior art,

FIG. 2 is a exterior view of an exemplary embodiment having a housing block,

FIG. 3 is an exploded view of the exemplary embodiment according to the invention as shown in FIG. 2,

FIGS. 4 and 5 are views of the pipeline system provided in the housing block,

FIGS. 6 to 8 are views showing the flow through the exemplary embodiment according to the invention as shown in FIG. 2 in a first operating state,

FIGS. 9 and 10 are views showing the flow through the exemplary embodiment according to the invention as shown in FIG. 2 in a second operating state,

FIGS. 11 and 12 are views showing the flow through the exemplary embodiment according to the invention as shown in FIG. 2 in a third operating state, and

FIG. 13 is a view of an alternative according to the invention in the form of an expansion of the exemplary embodiment as shown in FIG. 2.

### DETAILED DESCRIPTION OF THE PREFERRED EMBODIMENTS

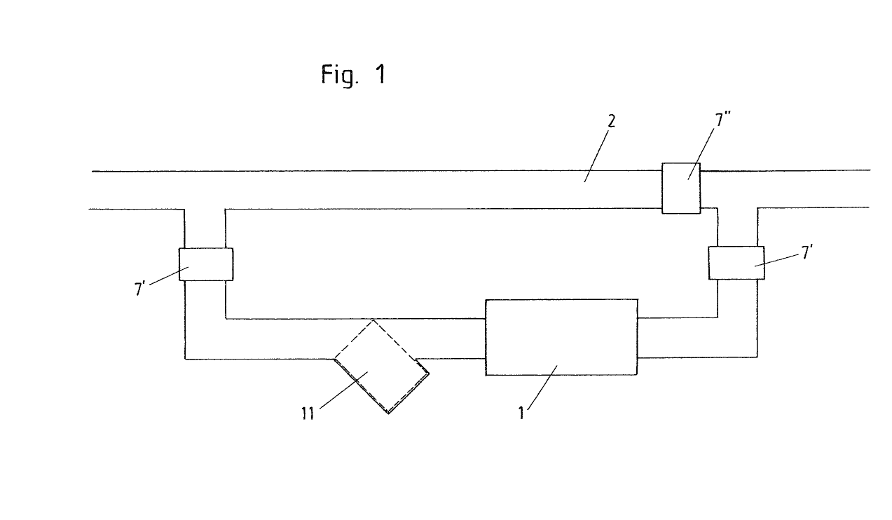

FIG. 1 illustrates an example according to prior art. During the normal operation the switching organs 7′ are opened and the switching organ 7″ is closed. The fluid and/or the liquid flows through the dirt trap 11 towards the flow meter 1. When the dirt trap 11 and/or the flow meter 1 are blocked the switching organs 7′ must be closed, operated manually or motor-driven, and the switching organ 7″ must be opened so that the fluid and/or the liquid can flow past the flow meter 1, flowing through the bypass line 2. Although the flow meter 1 usually is designed very small and sleek the arrangement overall still shows a considerable size and a considerable weight due to the required bypass line.

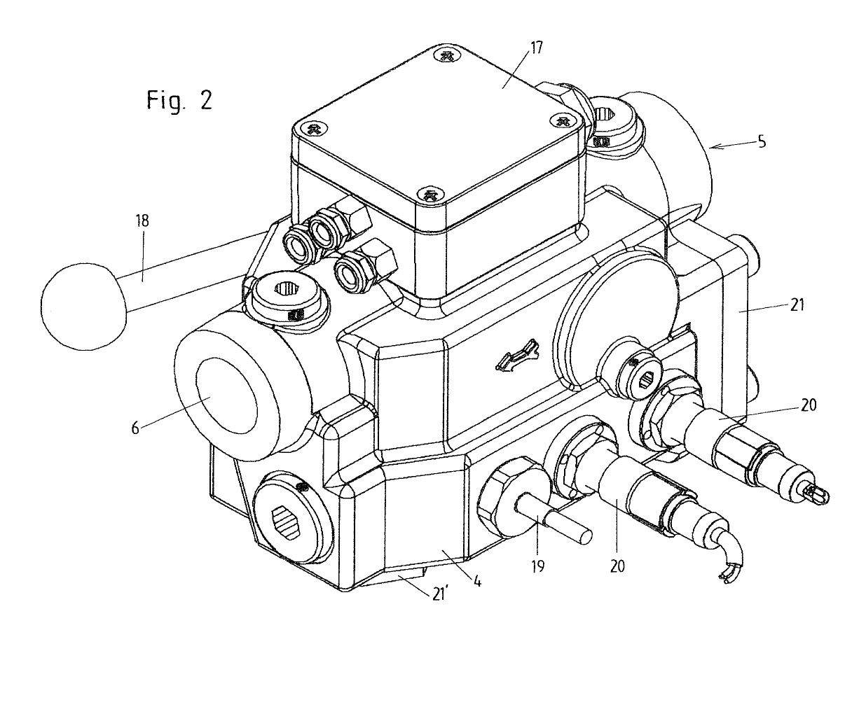

In order to remove said disadvantage of prior art, a housing block 4 is provided having at least one inlet opening 5 and at least one outlet opening 6, with the flow meter 1 and the bypass line 2 being arranged jointly inside the housing block 4, so to speak, and the in a first operational state inlet opening 5 is connected to the outlet opening 6 via the flow meter 1 and in at least one second operating state connected via the bypass line 2. Such an arrangement according to the invention exhibits the exterior as seen in FIG. 2. The fluid, particularly the liquid, flows via the inlet opening 5 into the housing block 4 and exits the housing block 4 via the outlet opening 6. The inlet opening 5 and the outlet opening 6 are beneficially arranged coaxially in reference to each other inside the housing block 4, as shown in FIG. 2. Using the manual operating lever 18 a switching organ 7, shown in the following figures, can be adjusted in order to set the first operating state, in which the inlet opening 5 is connected to the outlet opening 6 via the flow meter 1 explicitly illustrated in the following figures. By switching the manual operating lever 18, the arrangement according to the invention is brought into a second operating state, in which the inlet opening 5 is connected to the outlet opening 6 via the bypass line 2, explicitly illustrated in the following figures. In addition to the already mentioned components, the temperature sensor 19, the transmitter 20 of the flow meter 1, the lid 21, and the closing screws 41 through 43 and the optionally provided switchbox 17 are visible from the outside are, which may be provided for connecting the transmitter 20 to the optional temperature sensor 19.

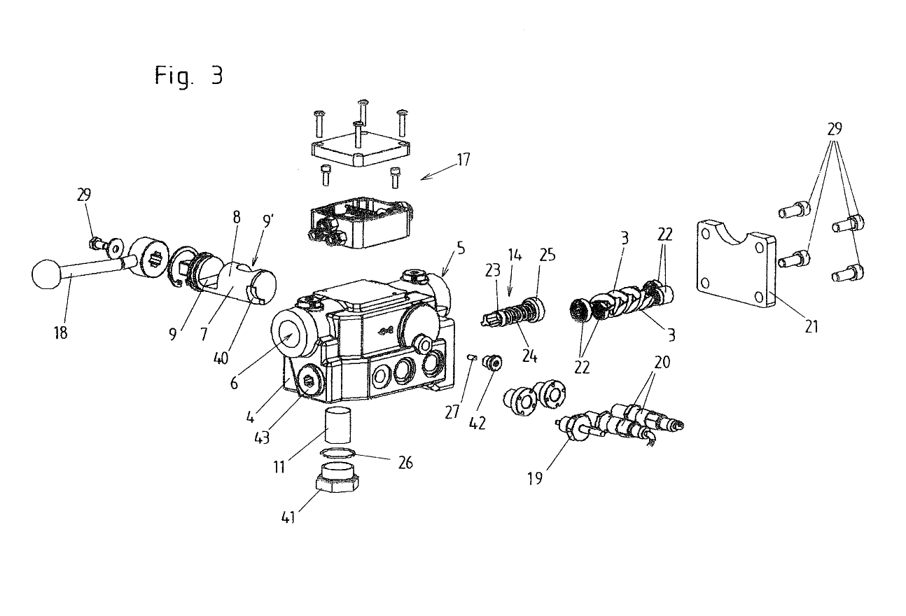

FIG. 3 shows the installations in the housing block 4, not visible from the outside in the assembled state according to FIG. 2, in an exploded illustration. First, reference is made here to the switching organ 7 connected in a rotationally fixed fashion to the manual operating lever 18. In the exemplary embodiment shown, the organ is embodied as a cylinder rotationally supported inside the housing block 4. Two flow channels 9 and 9′ are arranged in the cylinder, aligned orthogonally in reference to each other and completely separated from each other by at least one intermediate wall 8. Instead of an orthogonal arrangement of the flow channels, they may also be arranged aligned diagonally, i.e. neither parallel nor orthogonal in reference to each other. The operating manner of said switching organ and the flow channels 9 and 9′ is explained in greater detail in the following, using the figures. Of course, instead of the manual operating lever 18, an automatic operation of the switching organ 7, known per se, may also be provided. However, in the exemplary embodiment shown it is provided that the switching organ 7 can be rotated by 90° around its longitudinal axis. The stop pin 27 in the housing block 4, held by the closing screw 42, engages a groove-shaped recess 40 of the switching organ 7 and thus limits the potential settings of the switching organ 7 to the desired angular range of 90°.

In the exemplary embodiment shown, two spindles 3 are provided as measuring organs of the flow meter 1, which are supported rotationally in the housing block 4 via the bearing 22 and engage each other, preferably sealed from each other. The measuring principle of these spindles engaging each other is known in prior art and requires no detailed explanation. The rotation of the spindles 3 is measured via the transmitter 20, also known per se, by the transmitter registering when and how frequently it contacts the screw-shaped threads of the spindle(s) 3. Using a processing routine, known per se, the rotation of the spindles 3 and thus the flow volume can be calculated. In the exemplary embodiment shown, the transmitter 20 as well as the optional temperature sensor 19 are embodied as exchangeable bodies, that are pushed in and/or screwed in.

A dirt trap 11 is arranged upstream in reference to the flow meter 1. The trap is held by the closing screw 41 in the housing block 4 and serves to prevent the intrusion of contaminants into the flow meter 1. For example, tubular sieves or other filters known per se in prior art may be used as the dirt traps 11.

The pressure relief valve 14 is also embodied as an inserted body. It comprises a valve body 23, which is pressed by a spring 24 against a valve seat in the housing block 4. The amount of force pressing the valve body 23 against the valve seat can be adjusted via the adjustment screw 25. By adjusting the adjustment screw 25, the spring 24 is pre-stressed to a greater or lesser degree. While the flow meter 1 and/or the measuring spindles 3 and the bearing 22 are arranged in the housing block 4, shown in the following in a receiving chamber 33, in the exemplary embodiment shown the pressure relief valve 14 is installed in the additional bypass line 12 shown in the following figures. The pressure relief valve 14 as well as the measuring spindles 3 and their bearing 22 may be inserted into the housing block 4 via appropriate lateral openings therein. These openings are then closed by a lid 21, by connecting it to the housing block 4 using screws 29. The closing screws 43 closes an opening in the housing block 4 located opposite the lid 21.

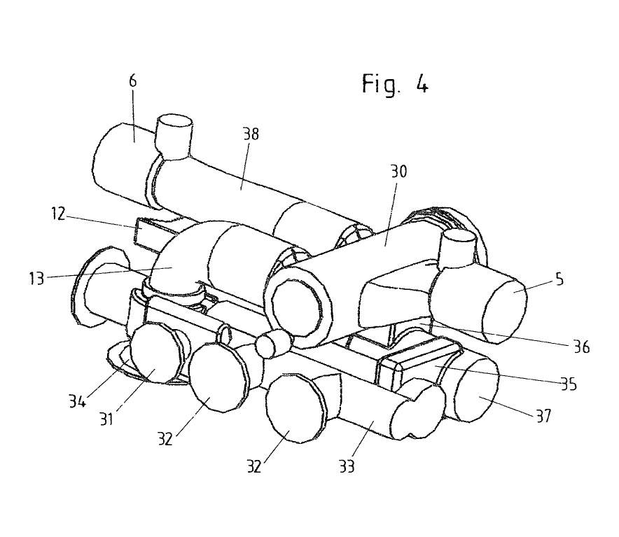

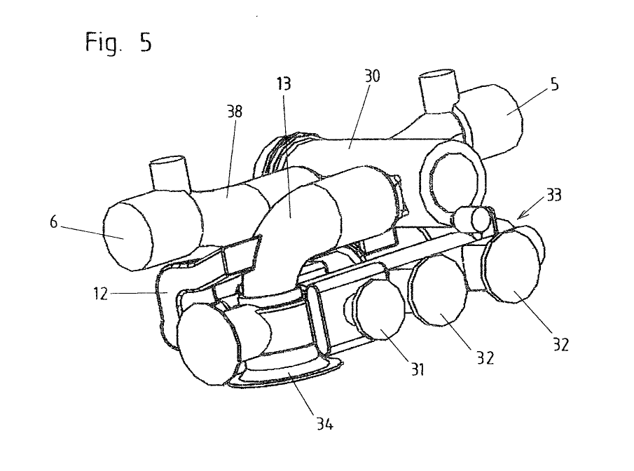

In FIGS. 4 and 5, for the purpose of explanation, perspective illustrations of the exterior contours, show the pipeline systems arranged inside the housing block 4. The fluids enter via the inlet opening 5 and are guided immediately to the receiving chamber 30 for the switching organ 7. From here, depending on the setting of the switching organ 7, there are two paths for the fluid to continue flowing. On the one hand, the switching organ 7 is switched in the second operating position such that the fluid, immediately coming from the inlet opening 5, can flow through the flow channel 9 to the outlet line 38 and thus to the outlet opening 6, here leaving the housing block 4. In this second operating position the flow meter 1 is therefore circumvented and fluid does not flow therethrough. When the switching organ 7 is in its second position, the fluid coming from the inlet opening 5 passes the switching organ 7, located in the receiving chamber 30, through the flow channel 9′ towards the line section 13. The line section 13 leads to the receiving chamber for the dirt trap 11, into which the dirt trap can be inserted through the opening 34. The receiving chamber 33 for the flow meter 1 follows the receiving chamber for the dirt trap 11. The openings 32 for the transmitter 20 and the opening 31 for the temperature sensor 19 open into the receiving chamber 33. When passing through the receiving chamber 33, the fluid mandatorily flows through the measuring spindles 3 of the flow meter 1, causing them to rotate, which in turn is measured and/or assessed by the transmitters 20. At the end of the receiving chamber 33, the fluid then flows via the connecting line 35 into the chamber 37 and therefrom via the connecting line 36 back to the receiving chamber 30 for the switching organ 7. Here, it passes the flow channel 9 of the switching organ 7 and is then guided to the outlet line 38 and thus to the outlet opening 6.

As is particularly well discernible in FIG. 5, the additional bypass line 12 forks off the line section 13. The position of this fork is located between the inlet opening 5 and/or the receiving chamber 30 and the receiving chamber 33 for the flow meter 1 and/or the upstream receiving chamber for the dirt trap 11. As already mentioned, the pressure relief valve 14 is arranged in the additional bypass line 12. The additional bypass line 12 in turn opens in the chamber 37. From here, the connecting line 36 leads via the receiving chamber 30 for the switching organ 7 to the outlet line 38 and thus to the outlet opening 6.

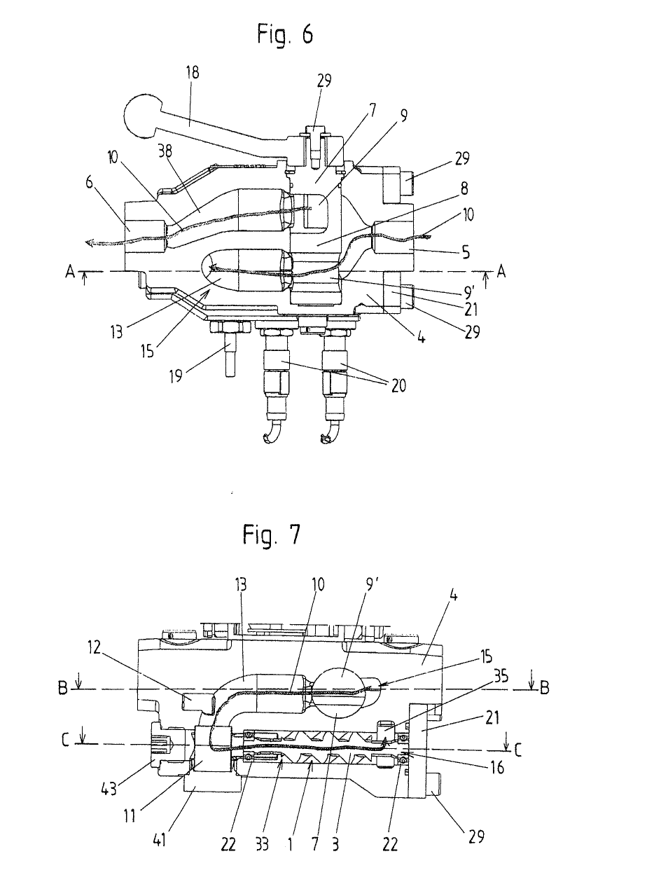

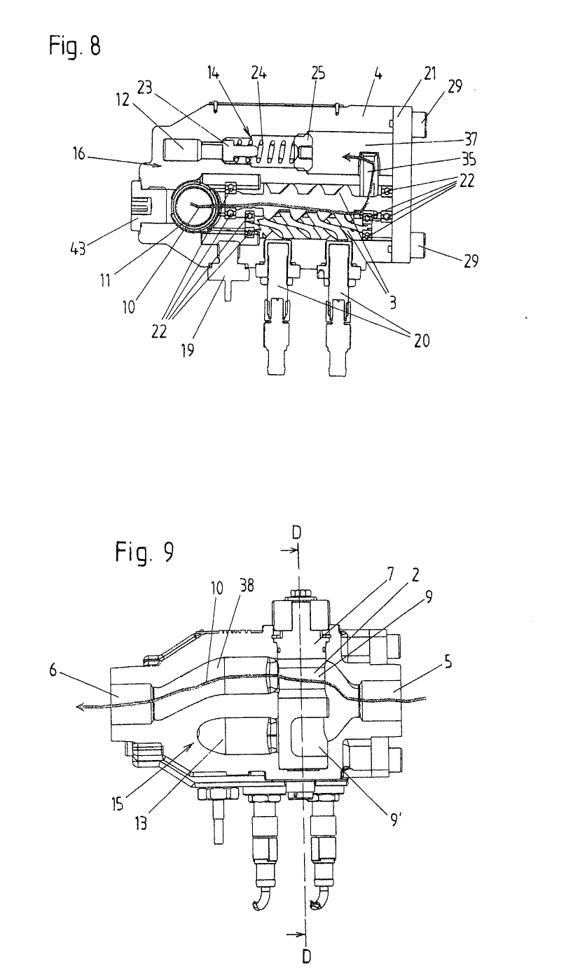

Using FIGS. 6 through 8, now the flow through the housing block 4 and/or the entire arrangement is illustrated in a first operating state using three cross-sectional representations. FIG. 6 shows a horizontal cross-section through the upper level 15 of the housing block 4, FIG. 7 shows a vertical cross-section along a sectional line A-A discernible in FIG. 6. In FIG. 7 in turn the sectional lines B-B of the cross-section according to FIG. 6 and the sectional line C-C of the cross-section through the lower level 16 are shown, as indicated in FIG. 8. FIGS. 6 through 8 illustrate the situation of the first operating state, in which no fluid flows through the bypass line 2 or the additional bypass line 12 but it flows through the flow meter 1. For reasons of clarity, the directions of flow are indicated in form of arrows 10. In the first operating state the inflowing fluid flows from the inlet opening 5 via the appropriately set flow channel 9′ to the line section 13. All this occurs in the upper level 15, which is shown in FIG. 6. FIG. 7 shows how the fluid then, following the line section 13, is guided to the dirt trap 11 in the lower level 16. In said trap any potentially present suspended particles and other contaminants are filtered out of the fluid. For this purpose, in the exemplary embodiment shown the dirt trap 11 is embodied tube-shaped. It can be cleaned by removing the closing screw 41.

Coming from the dirt trap 11, the fluid enters the receiving chamber 33, in which the flow meter 1 is arranged. The fluid passes the measuring spindles 3, causing them to be rotated according to the amount flowing through, which in turn is registered by the two transmitters 22. At the end of the measuring spindles 3 the fluid flows into the connecting line 35 and therefrom into the chamber 37, as shown particularly clearly in FIG. 8. From here, the fluid leaves the lower level 16 and, as particularly well discernible from FIG. 6, enters through the appropriately set flow channel 9 into the outlet line 38 and is guided from here to the outlet opening 6 of the housing block 4. Thus, in the first operating state illustrated in FIGS. 6 through 8 the entire fluid entering through the inlet opening 5 is guided through the measuring device 1, thus measuring the entire volume flow.

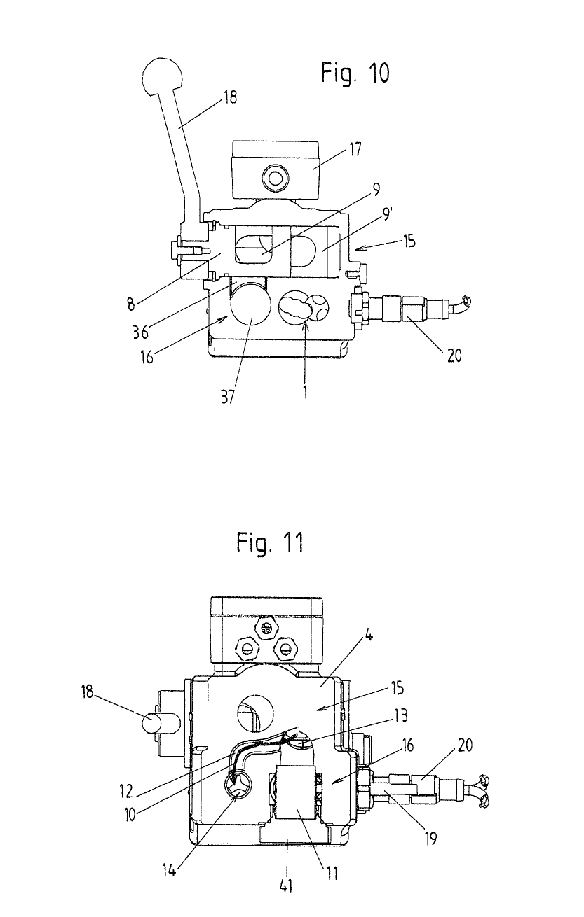

Now, FIGS. 9 and 10 show the second operating state, in which the inlet opening 5 is connected to the outlet opening 6 via the bypass line 2. Here, the switching organ 7 is set such that the flow channel 9′ is pivoted so that no fluid can flow into the line section 13. All fluid entering the inlet opening 5 is directly guided through the flow channel 9 to the outlet line 38 and thus to the outlet opening 6. Here, the appropriately set flow channel 9 forms the bypass 2. In this operating state the fluid flows through the housing block 4 and thus exclusively in the upper level 15. No fluid enters the lower level 16. FIG. 9 shows the sectional line D-D of the vertical cross-section of FIG. 10.

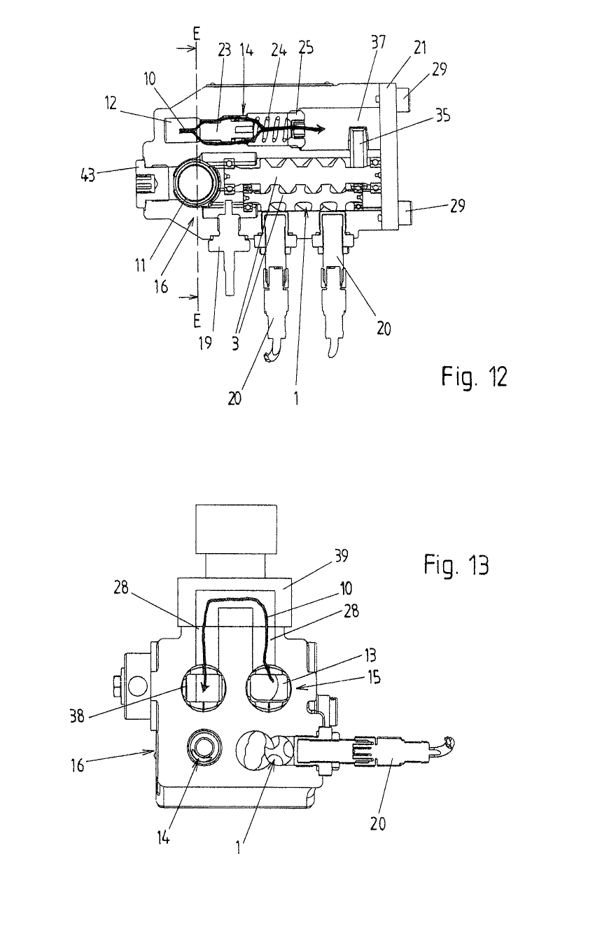

FIGS. 11 and 12 illustrate a third operational state. Here, the switching organ 7, as shown in FIG. 6, is set such that the bypass 2 is blocked. The fluid first flows, coming from the inlet opening 5, via the flow channel 9′ set in the opening position, to the line section 13. Here, however the fluid accumulates in the third operational state due to a clogged dirt trap 11 or by blocked measuring spindles 3 so that it no longer can continue the flow path intended in the first operating state. As soon as the pressure developing in this situation exceeds the pressure limit of the pressure relief valve 14, adjusted by the adjustment screw 25, the valve body 23 is lifted off its valve seat and compresses the spring 24, so that fluid, as shown in FIG. 12, can now flow past the valve body 23, set in the opening position, through a central opening in the adjustment screw 25 into the chamber 27. From here, through the connecting line 36 the fluid can enter unhindered the upper level and/or, via the flow channel 9, set as shown in FIG. 6, the outlet line 38 and thus the outlet opening 6. Thus, in this third operating state the bypass 2 is closed. When, due to a sufficiently soiled dirt trap 11 or by blocked measuring spindles 3, an appropriate pressure develops in the fluid, the fluid can flow out via the pressure relief valve 14. In this way an appropriate overpressure safety is created. FIG. 11 shows the cross-section along to the sectional line E-E shown in FIG. 12.

FIG. 13 shows an expansion of the above-described exemplary embodiment according to the invention. In this expansion, in addition to the switch organ 7 manually operated to open an additional line 28, an additional switching organ 39 is provided, which can be opened and closed electrically or otherwise remotely controlled. Through this additional line 28, the additional switching organ 39 is connected on the one side to the line section 13 and on the other side to the outlet line 38. When now the manually operated switching organ 7 is positioned in the setting of the first operating state according to FIG. 6 another bypass can be opened via the additional line 28 by opening the additional switching organ 39. In a closed state of the additional switching organ 39, this additional bypass is not active, and the additional line 28 is closed. This additional, particularly remote-controlled bypass option by the additional switching organ 39 may be of interest for applications of the arrangement according to the invention, when the switching organ 7 can only be operated manually, i.e. on site, and additionally a remote-controlled bypass options is required.

### LEGEND OF REFERENCE CHARACTERS

1 Flow meter
2 Bypass line
3 Measuring spindle
4 Housing block
5 Inlet opening
6 Outlet opening
7,7′,7″ Switching organ
8 Intermediate wall
9, 9′ Flow channel
10 Direction of flow
11 Dirt trap
12 Additional bypass line
13 Line section
14 Pressure relief valve
15 Level
16 Level
17 Switch box
18 Manual operating lever
19 Temperature sensor
20 Transmitter
21 Lid
22 Bearing
23 Valve body
24 Spring
25 Adjustment screw
26 Sealing ring
27 Stop pin
28 Additional line
29 Screw
30 Receiving chamber
31 Opening
32 Opening
33 Receiving Chamber
34 Opening
35 Connecting line
36 Connecting line
37 Chamber
38 Outlet line
39 Additional switching organ
40 Groove-shaped recess
41 Closing screw
42 Closing screw
43 Closing screw

1. An arrangement, comprising:
at least one flow meter for fluids which includes at least one rotationally supported measuring spindle;
at least one bypass line, via which the fluids can be guided past the flow meter;
a housing block with at least one inlet opening and at least one outlet opening, the flow meter and the bypass line being arranged inside the housing block; and
in a first operating state, the inlet opening is connected to the outlet opening via the flow meter, and in at least a second operating state, the inlet opening is connected to the outlet opening via the bypass line.

2. The arrangement according to claim 1, wherein the flow meter comprises at least two of the rotationally supported measuring spindles engaging each other.

3. The arrangement according to claim 1, wherein the housing block is embodied as one piece.

4. The arrangement according to claim 1, wherein the housing block is embodied as a one-piece molded part.

5. The arrangement according to claim 1, wherein at least one switching organ, which is operable manually or motor-driven, is arranged inside the housing block, with the switching organ connecting the inlet opening to the outlet opening in a first operating state via the flow meter and in the second operating state via the bypass line.

6. The arrangement according to claim 5, wherein the switching organ comprises or is a rotationally supported cylinder located inside the housing block.

7. The arrangement according to claim 6, wherein two flow channels are arranged in the cylinder, extending diagonally or orthogonally in reference to each other.

8. The arrangement according to claim 6, wherein two flow channels are arranged in the cylinder, completely separated from each other by at least one intermediate wall.

9. The arrangement according to claim 1, wherein a dirt trap is arranged or is positionable inside the housing block between the inlet opening and the flow meter, in a direction of flow of the fluids.

10. The arrangement according to claim 9, wherein the dirt trap comprises or is an exchangeably inserted body.

11. The arrangement according to claim 1, wherein an additional bypass line is arranged inside the housing block, via which the fluids can be guided past the flow meter, with the additional bypass line, seen in a direction of flow of the fluids, forking off between the inlet opening and the flow meter from a line section leading to the flow meter and leading to the outlet opening, and a pressure relief valve is arranged in the additional bypass line that can open when a fixed or adjustable pressure limit is exceeded.

12. The arrangement according to claim 9, wherein an additional bypass line, via which the fluids can be guided past the flow meter, is arranged inside the housing block, with the additional bypass line, seen in a direction of flow of the fluids, forking off between the inlet opening and the flow meter from a line section leading to the flow meter and leading to the outlet opening, and a pressure relief valve is arranged in the additional bypass line that can be opened by the fluid when a fixed or adjustable pressure limit is exceeded, and the additional bypass line, in the direction of flow of the fluids, forks off between the inlet opening and the dirt trap.

13. The arrangement according to claim 1, wherein the inlet opening and the outlet opening are arranged coaxially in reference to each other in the housing block.

14. The arrangement according to claim 1, wherein inside the housing block, a pipeline system is formed in at least two levels connecting the inlet opening to the outlet opening.

15. The arrangement according to claim 14, wherein the levels are arranged one over another.

16. The arrangement according to claim 14, wherein the inlet opening and the outlet opening are both arranged in a same one of the levels.

17. The arrangement according to claim 16, wherein at least one manually or motor-driven operated switching organ is arranged inside the housing block, with the switching organ connecting the inlet opening to the outlet opening in the first operating state via the flow meter and in the second operating state via the bypass line, and the bypass line and the switching organ are both arranged in a same one of the levels.

18. The arrangement according to claim 17, wherein the inlet opening, the outlet opening, the bypass line and the switching organ are arranged in a same one of the levels.

19. The arrangement according to claim 14, wherein the flow meter is arranged in a different one of the levels than at least one component selected from a group comprising the inlet opening, the outlet opening, the bypass line and the switching organ.

20. The arrangement according to claim 14, wherein the flow meter is arranged together with a pressure relief valve, provided in an additional bypass line in a different one of the levels than at least one component selected from a group comprising the inlet opening, the outlet opening, the bypass line and the switching organ.

21. The arrangement according to claim 1, wherein the flow meter is a flow meter for liquids.
